(19) United States
(12) Patent Application Publication
(10) Pub. No.: US 2023/0280945 A1
(43) Pub. Date: Sep. 7, 2023

(54) STORAGE SYSTEM AND CONTROL METHOD FOR STORAGE SYSTEM

(71) Applicant: Hitachi, Ltd., Tokyo (JP)

(72) Inventors: Ryosuke TATSUMI, Tokyo (JP); Takashi NAGAO, Tokyo (JP); Kazuki MATSUGAMI, Tokyo (JP)

(21) Appl. No.: 17/942,310

(22) Filed: Sep. 12, 2022

(30) Foreign Application Priority Data
Mar. 3, 2022 (JP) 2022-032445

(51) Int. Cl. G06F 3/06

(52) U.S. Cl. CPC G06F 3/0679; G06F 3/0619; G06F 3/0655

(57) ABSTRACT

A storage system holds upper mapping information and lower mapping information. The upper mapping information manages an address relationship between a logical device upper layer accessed by a host and a logical device middle layer. The lower mapping information manages an address relationship between the logical device middle layer and a logical device lower layer. The lower mapping information includes pieces of partial mapping information. Each of the pieces of partial mapping information manages address information of a partial area in the logical device middle layer. The storage system writes, in response to a failure of first partial mapping information in the lower mapping information, new data that fills a first partial area in the logical device middle layer managed by the first partial mapping information, and regenerates the first partial mapping information.

### CLAIM OF PRIORITY

The present application claims priority from Japanese patent application JP 2022-032445 filed on Mar. 3, 2022, the content of which is hereby incorporated by reference into this application.

### BACKGROUND OF THE INVENTION

### 1. Field of the Invention

The present invention relates to a storage system and a control method for a storage system.

### 2. Description of the Related Art

In order to reduce bit cost of a storage, deduplication and compression techniques are used. On the premise that malware or the like logically destroys data, there is a demand for a snapshot function that enables highfrequency backups and rapid recovery. As a method for implementing the snapshot function, for example, a redirect on write (RoW) method for duplicating/restoring conversion information is known.

A deduplication function and an RoW snapshot function have a logical data position and a physical data position in a relationship of N:1. Asynchronous processing of each function has different device layers (address space layers) in order to narrow down a processing target.

For example, a storage controller disclosed in US Patent No. 9646039 (Patent Literature 1) receives a request for deleting a first volume, and in response to the request, deletes a link between the first volume and an anchor medium thereof. The storage controller also delays deletion of the anchor medium of the first volume. When the user wants to restore the first volume later, the storage controller reconnects the first volume to the previous anchor medium, effectively restores the first volume to a previous state, and cancels a deletion operation.

In a device layer combining the deduplication/compression function and the RoW snapshot function, conversion information from a snapshot management device to a deduplication/compression management device may be managed in units of a certain range (slot) of the conversion information. When the conversion information cannot be read due to a certain failure, logical-physical conversion of all logical addresses in a corresponding slot cannot be performed. Difference data of snapshots of a plurality of generations for a certain logical volume may be stored in one slot. There may also be an area that is not used for snapshots of any generation.

Therefore, when the conversion information is damaged, data of one slot cannot be prepared in one host write, and the conversion information cannot be regenerated to recover from a failure state. When recovering the conversion information by formatting a logical volume, the amount of data lost is large and system recovery takes time.

### SUMMARY OF THE INVENTION

A storage system according to an aspect of the invention includes a controller. The controller manages a logical device upper layer accessed by a host, a logical device lower layer, and a logical device middle layer between the logical device upper layer and the logical device lower layer. The controller holds upper mapping information for managing an address relationship between the logical device upper layer and the logical device middle layer, and lower mapping information for managing an address relationship between the logical device middle layer and the logical device lower layer. The lower mapping information includes a plurality of pieces of partial mapping information. Each of the plurality of pieces of partial mapping information manages address information of a partial area in the logical device middle layer. The controller writes, in response to a failure of first partial mapping information in the lower mapping information, new data that fills a first partial area in the logical device middle layer managed by the first partial mapping information, and regenerates the first partial mapping information.

According to the aspect of the invention, it is possible to reduce the amount of data to be formatted for recovery from a failure in the mapping information and to shorten time until recovery.

Problems to be solved, configurations and effects other than those described above will be clarified by description of the following embodiment.

### BRIEF DESCRIPTION OF THE DRAWINGS

FIG. 1 is a diagram showing a configuration example of a computer system according to an embodiment of the present specification;

FIG. 2 shows a configuration of logical device layers managed by a controller (storage system);

FIG. 3 shows an area configuration in a memory;

FIG. 4 schematically shows mapping information that associates logical device layers and addresses between logical device layers;

FIG. 5 shows a configuration example of snapshot management information;

FIG. 6 shows a configuration example of directory information;

FIG. 7 shows a configuration example of snapshot store space mapping information;

FIG. 8 shows a configuration example of pool management information;

FIG. 9 shows a configuration example of pool mapping information;

FIG. 10 shows a configuration example of guarantee code management information;

FIG. 11 shows a configuration example of cache slot management information;

FIG. 12 shows a configuration example of failure address management information;

FIG. 13 shows a configuration example of block reference source management information in a snapshot store space;

FIG. 14 shows an example of a failure range format instruction screen for a first failure recovery method;

FIG. 15 shows a flowchart of an example of failure target range search processing;

FIG. 16 shows a flowchart of an example of failure data recovery processing;

FIG. 17 shows an example of a failure range format instruction screen for a second failure recovery method;

FIG. 18 shows a flowchart of an example of front end write processing;

FIG. 19 shows a flowchart of an example of intermediate write processing;

FIG. 20 shows a flowchart of an example of write destination snapshot store space address acquisition processing;

FIG. 21 shows a flowchart of an example of back end write processing; and

FIG. 22 shows a flowchart of an example of additional writing processing.

### DESCRIPTION OF THE PREFERRED EMBODIMENTS

Hereinafter, an embodiment of the present disclosure will be described with reference to the accompanying drawings. The embodiment described below does not limit the invention according to the claims, and all of combinations of features described in the embodiment are not necessarily essential to the solution to the problem of the invention.

In the following description, processing may be described using a “program” as a subject. The program is executed by a processor to perform predetermined processing by appropriately using a storage unit and/or an interface unit. Therefore, the subject of the processing may be a processor (or a device such as a controller having the processor).

The program may be installed from a program source into a device such as a computer. The program source may be, for example, a recording medium (for example, a non-transitory recording medium) readable by a program distribution server or a computer. In the following description, two or more programs may be implemented as one program, or one program may be implemented as two or more programs.

In the following description, an expression such as “xxx table” may be used to describe information for which an output can be obtained in response to an input, and the information may be data having any structure. In the following description, a configuration of each table is an example, and one table may be divided into two or more tables, or all or a part of the two or more tables may be one table.

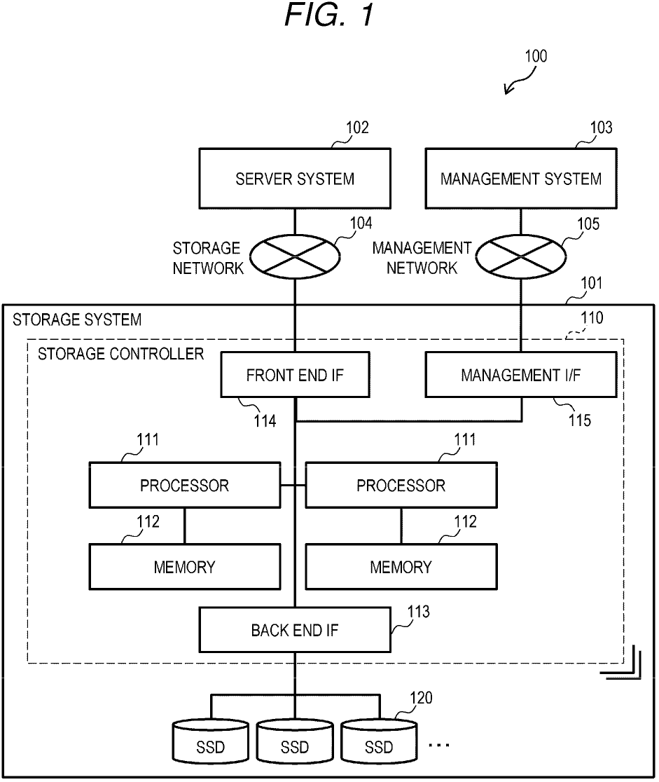

FIG. 1 is a diagram showing a configuration example of a computer system according to the embodiment of the present specification. The computer system includes a storage system 101, a server system (host) 102, a management system 103, a storage network 104 that connects the storage system 101 and the server system 102, and a management network 105 that connects the storage system 101 and the management system 103. FIG. 1 shows one storage system 101, one server system 102, and one management system 103, the numbers of which are freely selected.

The storage system 101 includes a plurality of storage controllers (hereinafter, also simply referred to as controllers) 110. Each controller 110 includes one or more microprocessors (hereinafter also referred to as processors) 111, one or more memories 112, one or more front end interfaces (I/Fs) 114, one or more back end I/Fs 113, and one or more management I/Fs 115. FIG. 1 shows, as an example, two processors 111, two memories 112, one front end I/F 114, one back end I/F 113, and one management I/F 115.

The plurality of controllers 110 are connected to each other by a path between controllers (not shown). The memories 112 are accessible by the processors 111, a direct memory access (DMA) circuit (not shown), or the like.

The front end I/F 114 is connected to the server system 102 through the storage network 104 such as a storage area network (SAN). The management I/F 115 is connected to the management system 103 through the management network 105 such as a local area network (LAN). Protocols of the storage network 104 and the management network 105 are freely selected as long as data communication can be performed.

The storage system 101 includes the back end I/F 113 that connects a plurality of storage drives (hereinafter also referred to as drives or storage devices) 120 and the controller 110. The drive 120 may be, for example, a hard disk drive (HDD), a solid state drive (SSD), or a tape-type storage device. The plurality of drives 120 can form a logical volume based on a physical storage area of one or more drives and provide the logical volume to the controller 110.

A plurality of drives may form a redundant array of independent disks (RAID) group for redundancy, and a logical volume may be provided from the RAID group. The logical volume can be provided as a volume (logical unit: also referred to as LU) accessible by the server system 102. A write request and a read request can be received via the storage network 104 by an address designated by the server system 102.

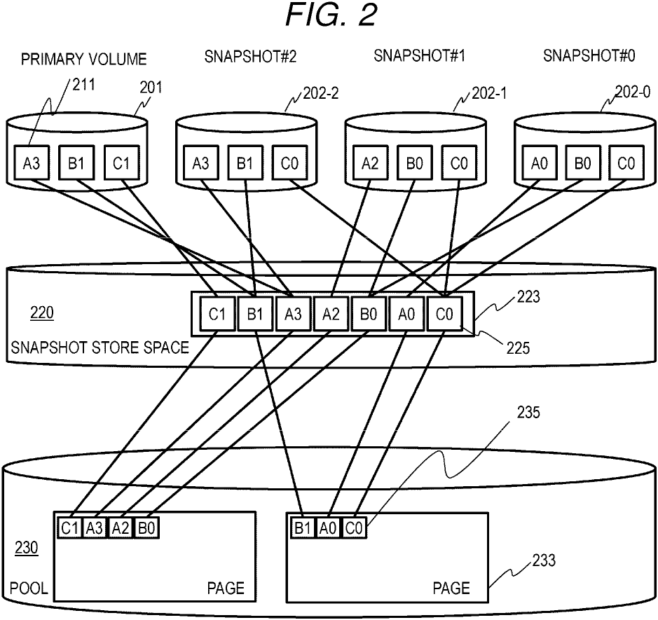

FIG. 2 shows a configuration example of logical device layers managed by the controller 110 (storage system 101). A configuration of the logical device layers includes an upper layer that includes a plurality of volumes accessible by the server system 102, a middle layer snapshot store space 220, and a lower layer pool 230. A snapshot function uses a volume in the upper layer and the snapshot store space 220. A deduplication/compression function uses the snapshot store space 220 and the pool 230. The storage system 101 may manage a plurality of snapshot store spaces 220 and a plurality of pools 230.

The logical device defines a virtual address space for virtually storing data, and does not physically store data. Actual data is stored in a medium of the storage drive 120 that is a physical device.

An address is associated between the volume in the upper layer and the middle layer snapshot store space 220, and an address is associated between the middle layer snapshot store space 220 and the lower layer pool 230. An address of the pool is associated with an address of the storage drive 120. Data stored in the pool 230 may be subjected to deduplication and/or compression processing. In the following description, the data stored in the pool 230 is subject to the compression processing. Data having a small compression effect can be stored in a pool without being compressed.

In the configuration example shown in FIG. 2, the upper layer includes a primary volume 201 and snapshots 202-0 to 202-2 of the primary volume 201. The snapshot is a volume that is accessible by the host. FIG. 2 shows three snapshots 202-0 to 202-2 for the primary volume 201 as an example, but the number of snapshots is freely selected.

The primary volume 201 stores latest host data. The snapshots 202-0 to 202-2 store data of the primary volume 201 at corresponding time points. The host data is managed in units of blocks having a certain size. In FIG. 2, each block is represented by a rectangle, and as an example, a block of data A3 is indicated by a reference sign 211. In FIG. 2, characters in the rectangle represent an identifier of host data, and the same identifier is given to a block of the same host data regardless of presence or absence of compression.

The storage system 101 according to the embodiment of the present specification adopts a redirect on write (RoW) method. In the RoW method, new data written to the primary volume 201 is written to the snapshot store space 220, and non-update data is maintained in the snapshot store space 220. The non-update data is associated with the snapshot, and new data is associated with the primary volume 201.

The snapshot store space 220 manages data in units of slots having a certain size. One slot stores a plurality of blocks, and FIG. 2 shows a slot 223 as an example. The block of the same host data stored in the snapshot store space 220 is one, and is associated with one or more blocks of the volume in the upper layer.

For example, a block of host data C0 is stored in the three snapshots (volumes) 202-0 to 202-1. One block 225 of the host data C0 in the slot 223 of the snapshot store space is associated with blocks of the host data C0 in the three snapshots 202-0 to 202-1.

The pool 230 stores compressed host data. The compressed data may be additionally written in the pool 230, that is, pre-packed and written in a free area. The pool 230 is managed in units of pages having a certain size, and one page can store a plurality of blocks. In FIG. 2, as an example, one page is denoted by a reference sign 223, and one block in the page is denoted by a reference sign 235. Characters in the block are identifiers of the host data. A block 235 of the host data C0 indicates a block of compressed host data C0.

Each block in the snapshot store space is associated with one block in the pool 230. Although not shown in FIG. 2, each block of the pool 230 is associated with a block stored in the storage drive 120. Features of the present disclosure can be applied to a logical device layer structure including logical device layers different from the logical device layers shown in FIG. 2.

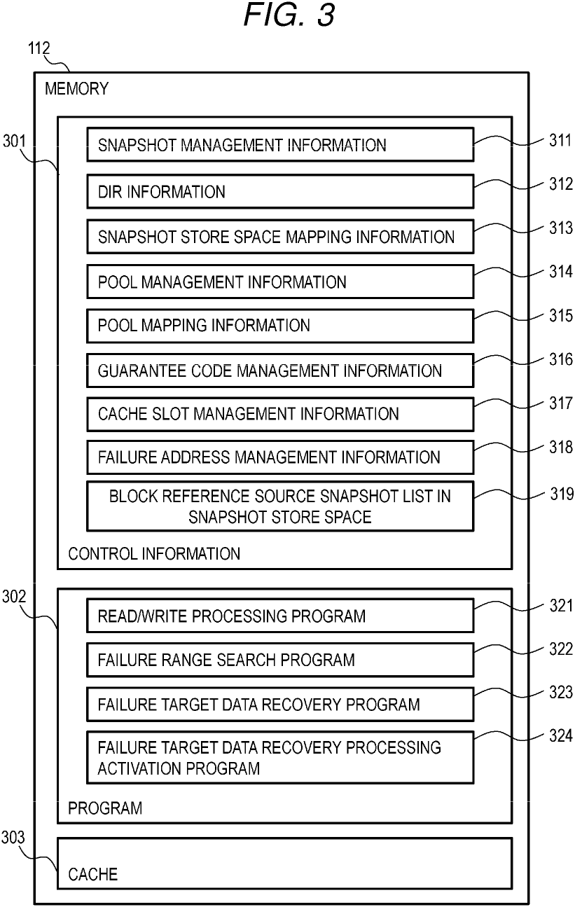

FIG. 3 shows an area configuration in the memory 112. The memory 112 includes a control information storage area 301, a program storage area 302, and a cache area 303. The control information storage area 301 stores information for managing a logical device layer. FIG. 3 shows snapshot management information 311, directory (DIR) information 312, snapshot store space mapping information 313, pool management information 314, pool mapping information 315, guarantee code management information 316, cache slot management information 317, failure address management information 318, and block reference source management information in a snapshot store space 319. Details of these pieces of information will be described later.

The program storage area 302 stores a program to be executed by the processor 111. FIG. 3 shows a read/write processing program 321, a failure range search program 322, a failure target data recovery program 323, and a failure target data recovery processing activation program 324. Details of processing of these programs will be described later.

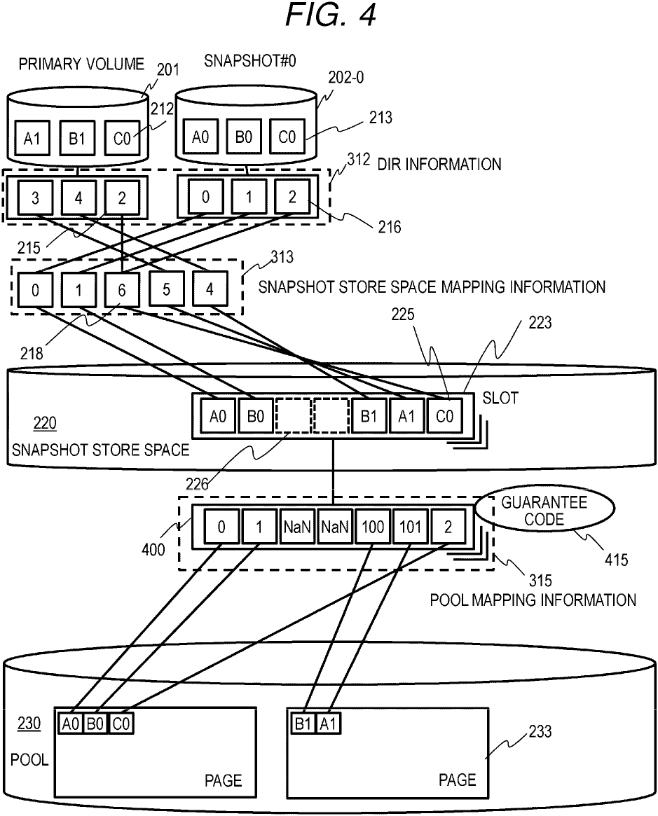

FIG. 4 schematically shows mapping information that associates logical device layers and addresses between logical device layers. The directory information 312 associates the block of the volume in the upper layer with an entry of the snapshot store space mapping information 313. For example, a block 212 of the primary volume 201 and a block 213 of the snapshot 202-0 store the host data C0.

The block 212 of the primary volume 201 is associated with an entry 218 of the snapshot store space mapping information 313 via an entry 215 of the directory information 312. The block 213 of the snapshot 202-0 is associated with the entry 218 of the snapshot store space mapping information 313 via an entry 216 of the directory information 312. Since the blocks 212 and 213 store the same host data C0, the blocks 212 and 213 are associated with the common entry 218 of the snapshot store space mapping information 313.

The entry of the snapshot store space mapping information 313 indicates a block in the snapshot store space 220. Thus, the snapshot store space mapping information 313 is upper mapping information, and associates the block of the volume in the upper layer with the block in the snapshot store space 220.

As described above, the snapshot store space 220 is managed in units of slots. In FIG. 4, a dashed-line rectangle 226 in the slot 223 indicates an unallocated block to which host data (block) in the upper layer is not allocated. A solid-line rectangle 225 indicates a block to which host data (block) in the upper layer is allocated. In FIG. 4, one unallocated block is indicated by a reference sign 226 as an example, and one allocated block is indicated by a reference sign 225 as an example.

One slot may include one or a plurality of unallocated blocks, and may include blocks allocated to blocks of different volumes. In an example of FIG. 4, the slot 223 includes two unallocated blocks 226. The slot 223 includes a block allocated to a block of the primary volume 201 and a block allocated to a block of the snapshot 202-0.

The pool mapping information 315 is lower mapping information, and includes a plurality of tables 400, and each table 400 is also referred to as a slot mapping table or slot mapping information. The slot mapping table 400 manages mapping information of each slot of the snapshot store space 220. A guarantee code 415 is allocated for the slot mapping table 400. The slot is a partial area of the snapshot store space 220, and is partial mapping information of the slot mapping table 400.

An entry of the slot mapping table 400 associates a block of the snapshot store space 220 with a block in the pool 230. The slot mapping table 400 indicates that an unallocated block in the snapshot store space 220 is unallocated.

In FIG. 4, a rectangle in the slot mapping table 400 indicates an entry, and a number in the rectangle indicates a reference destination page (reference destination address) in the pool 230. An entry for an unallocated block indicates “NAN”.

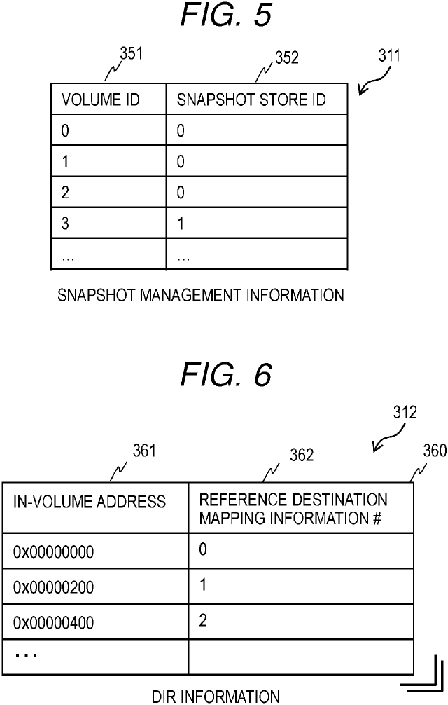

Hereinafter, control information stored in the memory 112 will be described. FIG. 5 shows a configuration example of the snapshot management information 311. The snapshot management information 311 manages a relationship between the volume (primary volume and snapshot) in the upper layer and the snapshot store space.

The snapshot management information 311 includes a volume ID column 351 and a snapshot store ID column 352. The volume ID column 351 indicates an ID of a volume in the upper layer that is accessible by the host. The snapshot store ID column 352 indicates an ID of a snapshot store space associated with the volume. Although FIGS. 2 or 4 shows one snapshot store space, the storage system 101 can define a plurality of snapshot store spaces.

FIG. 6 shows a configuration example of the directory information 312. The directory information 312 manages a relationship between a block of a volume in the upper layer and an entry in the snapshot store space mapping information 313. The directory information 312 includes a table 360 for managing information of each volume.

Each table 360 includes an in-volume (VOL) address column 361 and a reference destination mapping information number (#) column 362. The in-volume address column 361 indicates a start address of a block in the volume. A reference destination mapping information number column 362 indicates a reference destination mapping information number associated with a block in the volume. The mapping information number is an entry number in the snapshot store space mapping information 313.

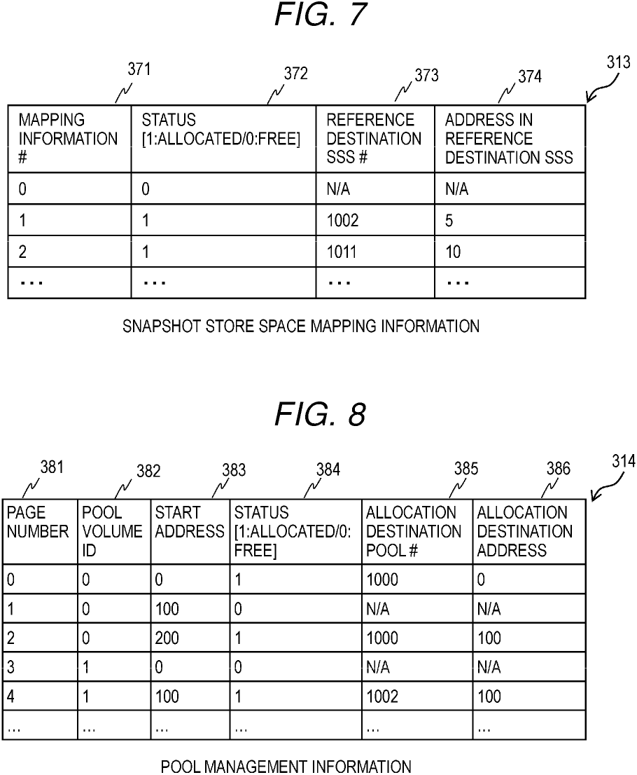

FIG. 7 shows a configuration example of the snapshot store space mapping information 313. The snapshot store space mapping information 313 manages allocation between a block of the volume in the upper layer and a block in the snapshot store space. The snapshot store space mapping information 313 includes a mapping information number column 371, a status column 372, a reference destination snapshot store space (SSS) number column 373, and an address in a reference destination snapshot store space column 374.

The mapping information number column 371 indicates a number for identifying an entry of the snapshot store space mapping information 313. A number in the mapping information number column 371 and a number in the reference destination mapping information number column 362 in the directory information 312 are associated with each other.

The status column 372 indicates whether a block in the snapshot store space 220 is allocated to a block in the volume to which an entry corresponds. A numerical value “1” indicates that the block is allocated and a numerical value “0” indicates that the block is not allocated. An allocated block in the volume means the block stores host data, and an unallocated block in the volume means the block does not store host data.

The reference destination snapshot store space number column 373 indicates a number of the snapshot store space as a reference destination of the block in the volume. That is, the reference destination snapshot store space column 373 indicates the number of the snapshot store space to which the block in the snapshot store space allocated to the block in the volume belongs. The number uniquely identifies the snapshot store space. The address in a reference destination snapshot store space column 374 indicates an address of the block in the snapshot store space allocated to the block in the volume. The address of the block is associated with a slot number and an in-slot offset.

FIG. 8 shows a configuration example of the pool management information 314. The pool management information 314 manages a relationship between the pool 230 and an address space (not shown) of the storage drive 120. The pool management information 314 includes a page number column 381, a pool volume ID column 382, a start address column 383, a status column 384, an allocation destination pool number column 385, and an allocation destination address column 386.

The page number column 381 indicates a number for identifying a page (actual storage area) allocated to the pool 230 from the address space of the storage drive 120. The pool volume ID column 382 indicates an ID of a pool volume to which a page is given. The pool volume is, for example, a logical device associated with a storage area of the storage drive 120 forming the RAID.

The start address column 383 indicates a start address of an area in the pool volume with which the page is associated. The status column 384 indicates whether a page is allocated to any of the pools. A numerical value “1” indicates that the page is allocated and a numerical value “0” indicates that the page is not allocated. The allocation destination pool number column 385 and the allocation destination address column 386 indicate the number of the pool as an allocation destination of the page and an internal address thereof.

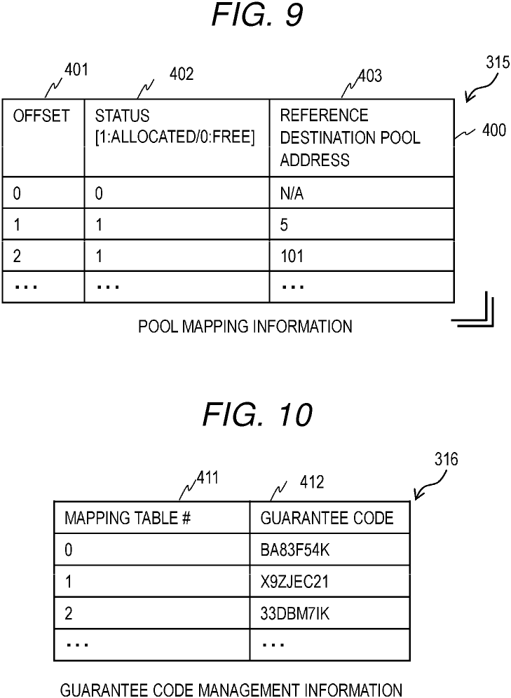

FIG. 9 shows a configuration example of the pool mapping information 315. The pool mapping information 315 includes a plurality of slot mapping tables 400 corresponding to one slot in the snapshot store space 220. The slot mapping table 400 manages a relationship between a slot and an in-pool address. The slot mapping table 400 includes an offset column 401, a status column 402, and a reference destination pool address column 403.

The offset column 401 indicates an offset for identifying a block in a slot. The status column 402 indicates whether an area in the pool 230 is allocated to a block. A numerical value “1” indicates that the area is allocated and a numerical value “0” indicates that the area is not allocated. An allocated block stores host data, and an unallocated block does not store host data.

The reference destination pool address column 403 indicates an address of an area in the pool 230 allocated to a block. As described above, data of a size smaller than a block size of the snapshot store space can be stored in the pool 230 by compression.

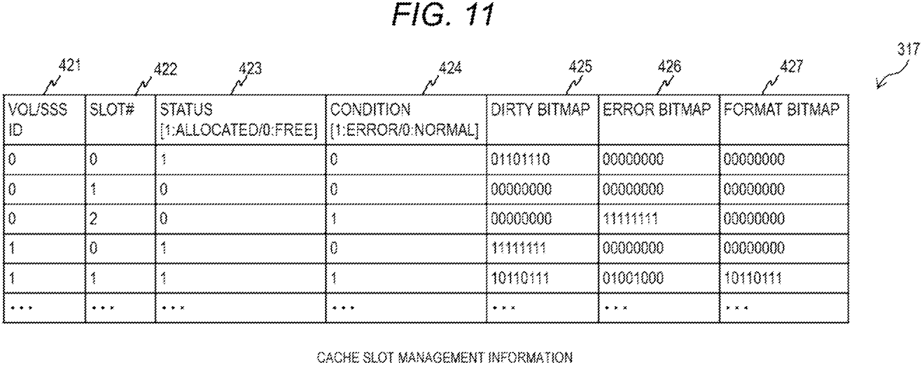

FIG. 10 shows a configuration example of the guarantee code management information 316. The guarantee code management information 316 manages a guarantee code of each slot mapping table 400 of the pool mapping information 315.

The guarantee code management information 316 includes a mapping table number column 411 and a guarantee code column 412. The mapping table number column 411 indicates a number for identifying the slot mapping table 400. The guarantee code column 412 shows a guarantee code of each slot mapping table 400. The guarantee code is, for example, Check sum, or CRC.

FIG. 11 shows a configuration example of the cache slot management information 317. The cache slot management information 317 manages a state of the volume in the upper layer and the slot of the snapshot store space 220. The slot is an area having a certain size, and a slot size of the volume in the upper layer and a slot size of a store space may be the same.

The cache slot management information 317 includes a volume/snapshot store space ID column 421, a slot number column 422, a status column 423, a condition column 424, a dirty bitmap column 425, an error bitmap column 426, and a format bitmap column 427.

The volume/snapshot store space ID column 421 indicates an ID for identifying a volume in the upper layer and a snapshot store space. An ID of the snapshot store space may be the same as a number thereof. The slot number column 422 indicates a number for identifying a slot in a volume or a snapshot store space. The status column 423 indicates whether an area of the cache 303 is allocated.

The condition column 424 indicates whether a failure occurs (whether the failure can be read normally) in pool mapping information of the slot. The dirty bitmap column 425 indicates a dirty block in the slot. A bit “1” indicates a dirty block. The error bitmap column 426 indicates an error block in the slot. A bit “1” indicates an error block. The format bitmap column 427 indicates a formatted block in the slot. Formatting means that normal data is newly written. A bit “1” indicates a formatted block.

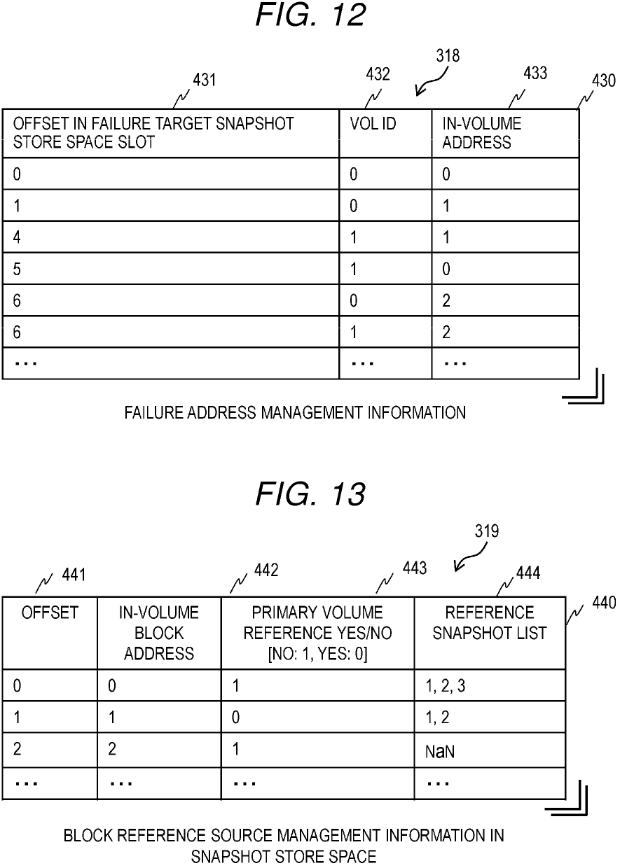

FIG. 12 shows a configuration example of the failure address management information 318. The failure address management information 318 includes a plurality of tables 430, and the table 430 is also referred to as a failure slot management table or failure cache slot management information. The failure slot management table 430 indicates a list of a volume and an in-volume address associated with the slot mapping table 400 in which a failure occurs in the pool mapping information 315. The volume associated with the slot mapping table 400 is a volume to which a block in the slot managed by the slot mapping table 400 is allocated. The block stores data of an allocation destination volume.

The failure slot management table 430 includes an offset in a failure target snapshot store space slot column 431, a volume ID column 432, and an in-volume address column 433. The offset in a failure target snapshot store space slot column 431 indicates a block in a slot managed by the slot mapping table 400 in which a failure occurs. The volume ID column 432 indicates an ID of a volume as the allocation destination of the block. The in-volume address column 433 indicates a block allocation destination address in a volume as an allocation destination of the block.

FIG. 13 shows a configuration example of the block reference source management information in a snapshot store space 319. The block reference source management information in a snapshot store space 319 manages a volume in the upper layer that refers to the block in the snapshot store space 220.

The block reference source management information in a snapshot store space 319 includes a plurality of tables 440, and is referred to as a block reference source list table or block reference source list information. The reference source list table 440 indicates a reference source volume of each block in a corresponding slot.

The reference source list table 440 includes an offset column 441, an in-volume block address column 442, a primary volume reference Yes/No column 443, and a reference snapshot list column 444.

The offset column 441 indicates an offset for identifying a block in a slot. The in-volume block address column 442 indicates an address in a volume in the upper layer that refers to a block of the snapshot store space. The block of the snapshot store space may be associated with a common address area of different volumes.

The primary volume reference Yes/No column 443 indicates whether the primary volume refers to the block in the snapshot store space 220. The reference snapshot list column 444 indicates an ID of a snapshot (volume) that refers to the block in the snapshot store space.

An operation of the storage system 101 will be described below. The storage system 101 executes normal access (read/write) to the volume from the server system 102, and also executes recovery processing of a failure in the pool mapping information 315.

In failure recovery processing, the storage system 101 writes data for formatting a slot (also referred to as a failure slot) corresponding to a damaged slot mapping table 400 into the snapshot store space 220. After the data of all blocks of the slot is written, the damaged slot mapping table 400 is regenerated. Accordingly, when the slot mapping table 400 is damaged, the slot can be formatted and recovered to an accessible state by writing data for one slot.

Hereinafter, two methods for recovery from a failure of the pool mapping information 315 will be mainly described. In the first method, the storage system 101 writes format data (also referred to as “0 data”) set in advance to all blocks of the failure slot, thereby formatting the slot.

In the second method, host data of a block allocated to a volume in the upper layer is received from the server system 102, and the host data is written to the block. Similarly to the first method, the format data (0 data) generated by the storage system 101 is written to a block not allocated to the volume in the upper layer. Accordingly, data desired by an administrator (user) can be rewritten, and the entire slot can be formatted by writing format data to an unallocated block invisible to the administrator.

In both of the first method and the second method, when writing data to the failure slot, the storage system 101 may allocate a cache area to the area in the snapshot store space 220 and stop write processing by writing to a cache segment. Thereafter, after data for one slot is available on the cache, compression and writing to the storage drive 120 via the pool 230 may be performed.

The storage system 101 can determine presence or absence of a failure in the slot mapping table 400 by checking the guarantee code. The slot can store data of a plurality of volumes. Therefore, when a failure state is determined, a target range of failure recovery may be distributed to a plurality of addresses of a plurality of volumes. The storage system 101 may register information of the volume associated with the failure slot in the failure address management information 318 and notify the management system 103 of the information. Accordingly, the administrator can know the host data stored in a slot in which the failure occurs.

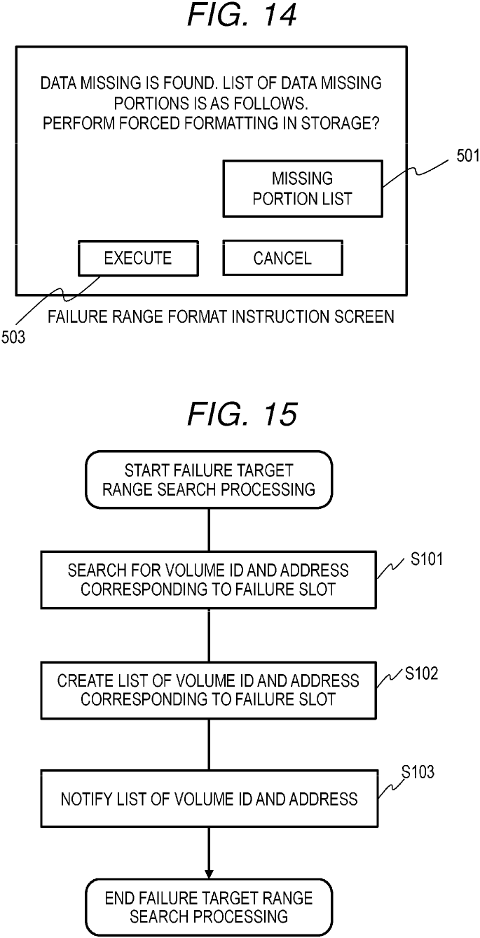

FIG. 14 shows an example of a failure range format instruction screen for the first failure recovery method above. As described above, in the first failure recovery method, the storage system 101 writes the format data to all the blocks of the failure slot.

When a failure in the pool mapping information 315 is detected, the failure range search program 322 displays a screen in the management system 103. When a “missing portion list” button 501 is selected, the failure target data recovery processing activation program 324 displays information of the host data associated with the damaged slot in the slot mapping table 400 in the management system 103.

Specifically, the failure range search program 322 refers to the failure address management information 318, generates a list of a volume ID and an in-volume address (LBA) to which a block of the failure slot is allocated, and displays the list of the volume ID and the in-volume address. Accordingly, the administrator can know a missing portion in the primary volume and the snapshot (volume). The failure address management information 318 is generated by the failure range search program 322.

When an “execute” button 503 is selected, the failure target data recovery program 323 generates format data (0 data) of one slot, and writes the format data into the slot of the snapshot store space 220 indicated by the damaged slot mapping table 400. The failure target data recovery program 323 regenerates the slot mapping table 400 for the slot, and notifies the management system 103 that the failure state is recovered. A failure address may be omitted, the management system 103 may be notified of occurrence of the failure, and the failure recovery may be executed in response to an instruction from the management system 103.

FIG. 15 shows a flowchart of an example of failure target range search processing. The failure range search program 322 searches for a volume ID and an address corresponding to a failure slot (S101). Specifically, the failure range search program 322 refers to the cache slot management information 317, and specifies the failure slot in the snapshot store space 220. An entry in which the condition column 424 indicates an error (“1”) indicates a failure slot. The failure range search program 322 refers to the block reference source management information in a snapshot store space 319, and acquires a volume (primary volume and snapshot) to which a block of the failure slot is allocated and the in-volume address.

Next, the failure range search program 322 creates a list of a volume ID and an in-volume address corresponding to the failure slot, generates the failure slot management table 430, and includes the failure slot management table 430 in the failure address management information 318 (S102). The failure target data recovery processing activation program 324 refers to the failure address management information 318, and notifies the management system 103 of the list of the volume ID and the in-volume address (S103). Generation of the failure slot management table 430 may be executed in response to detection of a failure slot in a system.

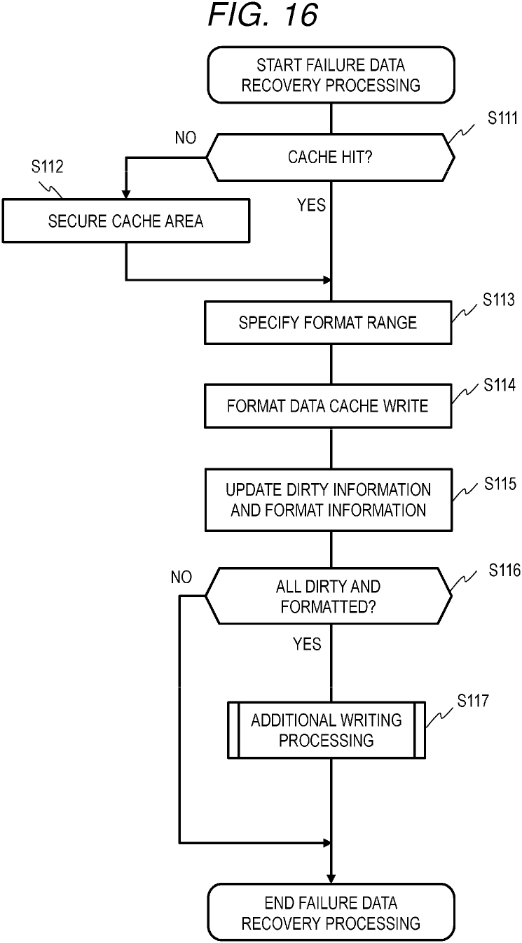

FIG. 16 shows a flowchart of an example of failure data recovery processing. In the failure data recovery processing, format data is written to the failure slot. The failure data recovery processing shown in FIG. 16 may be executed by the second failure recovery method in addition to the first failure recovery method. Hereinafter, a flow of processing in the first failure recovery method will be described.

The failure target data recovery program 323 determines whether an area for a slot in a damaged slot mapping table 400 is secured in the cache 303 (S111). Specifically, the failure target data recovery program 323 refers to the status column 423 in the cache slot management information 317, and determines whether an entry of a snapshot store space address of the slot indicates that the cache area is allocated or unallocated.

When the cache area is not secured (S111: NO), the failure target data recovery program 323 secures a cache area for the slot and updates the cache slot management information 317 (S112).

Next, the failure target data recovery program 323 determines a format range (S113). Here, the failure target data recovery program 323 is instructed by the administrator to perform forced formatting of the entire slot. Therefore, the format range is the entire slot.

Next, the failure target data recovery program 323 stores preset format data (0 data) in the secured cache area (S114). As described above, the format data of all the blocks is written. Further, the failure target data recovery program 323 updates the dirty bitmap column 425 and the format bitmap column 427 of the slot in the cache slot management information 317 (S115). The updated information indicates that all data in the slot is dirty and formatted.

Next, the failure target data recovery program 323 determines whether all the data in the slot is dirty and formatted (S116). As described above, since all the data in the slot is dirty (S116: YES), the failure target data recovery program 323 executes additional writing processing and stores the data of the slot in the pool 230 and the storage drive 120 (S117). Details of the additional writing processing will be described later.

Next, the second failure recovery method will be described. In the second failure recovery method, host data is used to format the failure slot, and format data generated in the storage system is stored for a block to which the host data is not written.

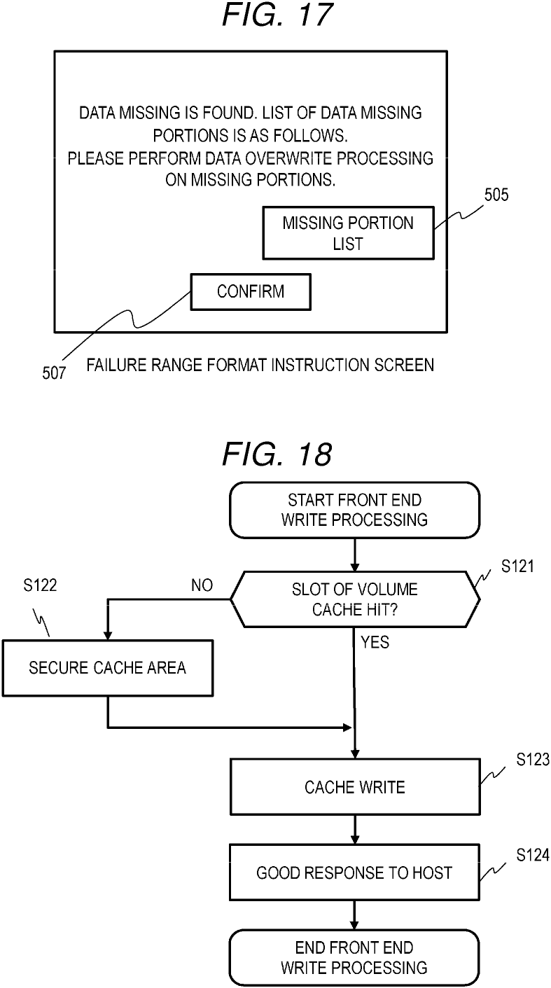

FIG. 17 shows an example of a failure range format instruction screen for the second failure recovery method above. When a failure in the pool mapping information 315 is detected, the failure range search program 322 displays a screen in the management system 103. When a “missing portion list” button 505 is selected, the failure range search program 322 displays information of the host data associated with the damaged slot in the slot mapping table 400 in the management system 103.

Specifically, the failure range search program 322 refers to the failure address management information 318, generates a list of a volume ID and an in-volume address (LBA) to which a block of the failure slot is allocated, and displays the list of the volume ID and the in-volume address. Accordingly, the administrator can know a missing portion in the primary volume and the snapshot (volume). The failure address management information 318 is generated by the failure range search program 322.

When a “confirm” button 507 is selected, the failure target data recovery program 323 executes formatting of the failure slot using the host data. The failure target data recovery program 323 waits for backup data from the server system 102 to be written to an address of each volume in the upper layer (primary volume or snapshot). For example, a storage administrator may confirm a failure address and notify a server administrator or a server user of the failure address. The server administrator and the server user can notify the server system 102 of execution of a command to write format data to an area from the management system 103.

After waiting for completion of the writing (on the cache) to the slot of the snapshot store space 220, the failure target data recovery program 323 regenerates the damaged slot mapping table 400. Format data generated in the system is written for a block that is not allocated to a volume in the upper layer. After regenerating the slot mapping table 400, the failure target data recovery program 323 notifies the management system 103 that the failure state is recovered.

FIG. 18 shows a flowchart of an example of front end write processing. The front end write processing receives new host data from the server system 102, stores the new host data in the cache 303, and returns a completion response to the server system 102. By the front end write processing, the host data is virtually stored in the volume of the upper layer. The new host data may be data written to a volume in normal write processing or data written for failure recovery of the pool mapping information 315.

Specifically, the read/write processing program 321 receives a write request from the server system 102 via the front end I/F 114. The read/write processing program 321 refers to the cache slot management information 317, and determines whether an area for the slot of the volume indicated by the write request is secured in the cache 303 (S121) .

When the cache area is not secured (S121: NO), the read/write processing program 321 secures the cache area and updates the cache slot management information 317 (S122). When the cache area is secured (S121: YES) or after a new cache area is secured (S122), the read/write processing program 321 writes the new host data to the allocated cache area. The read/write processing program 321 updates the cache slot management information 317 and returns a completion response to the server system 102 (S124).

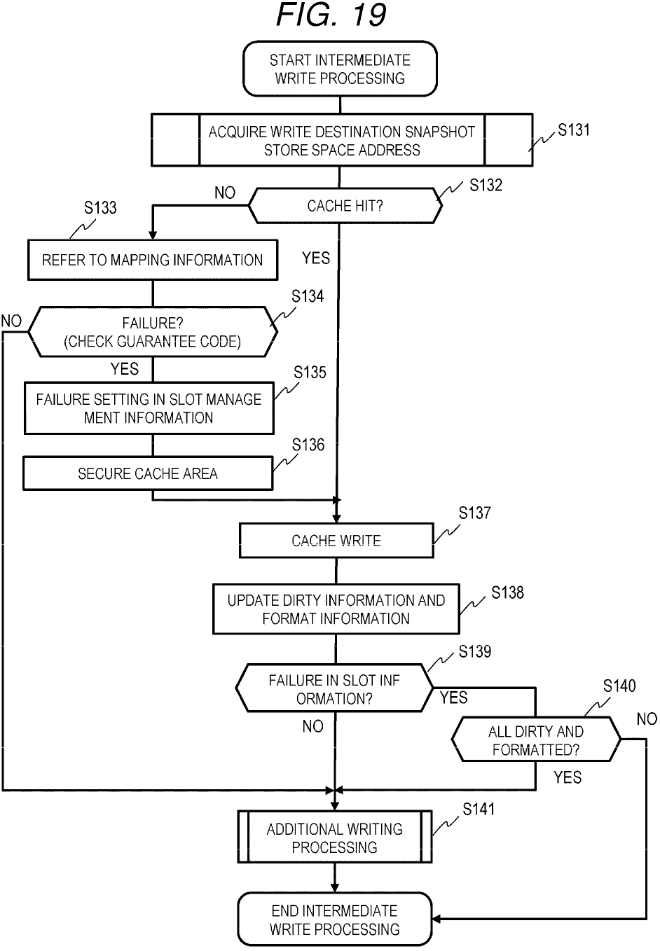

Next, intermediate write processing will be described. FIG. 19 shows a flowchart of an example of the intermediate write processing. In the intermediate write processing, the host data stored in the volume in the upper layer is virtually stored in the snapshot store space 220 and the pool 230, and is physically stored in the storage drive 120. Similarly to the front end write processing, target host data may be host data by normal write processing or host data for the failure recovery of the pool mapping information 315.

The read/write processing program 321 acquires a write destination snapshot store space address of the host data (S131). The write destination snapshot store space address is an address in the snapshot store space 220 associated with an address of a volume in which the new host data is written. A slot and a block can be specified by the address.

When there is an address already associated, the address is acquired, and when there is no address associated, a new address is allocated. Details will be described later. The address is managed in the snapshot store space mapping information 313.

Next, the read/write processing program 321 refers to the status column 423 of the cache slot management information 317, and determines whether an area corresponding to the acquired write destination snapshot store space address is secured in the cache 303 (S132).

When the cache area is not secured (S132: NO), the read/write processing program 321 refers to the slot mapping table 400 of a write destination slot in the pool mapping information 315 (S133). The read/write processing program 321 refers to the guarantee code management information 316, and determines whether there is a failure in the slot mapping table 400 (S134).

When there is no failure in the slot mapping table 400 (not damaged) (S134: NO), the read/write processing program 321 executes additional writing processing and stores data of the slot in the pool 230 and the storage drive 120 (S141). Details of the additional writing processing will be described later. The write processing of the host data to a slot that is not in a failure state and that is not secured is executed in this flow.

When there is a failure in the slot mapping table 400 (damaged) (S134: YES), the read/write processing program 321 performs failure setting of the slot in the condition column 424 of the cache slot management information 317 (S135). Further, the read/write processing program 321 secures a cache area for the slot in the cache 303 and updates the status column 423 of the cache slot management information 317 (S136).

When the cache area is secured (S132: YES) or after a new cache area is secured (S136), the read/write processing program 321 writes the host data to the cache area (S137).

The read/write processing program 321 updates dirty information and format information of the cache slot management information 317 in response to the writing of the host data to the cache area (S138). The read/write processing program 321 updates the dirty bitmap column 425 and the format bitmap column 427 of the slot. The updated cache slot management information 317 indicates that the block in which the host data is written is dirty and formatted in the failure slot.

The read/write processing program 321 refers to the condition column 424 of the cache slot management information 317, and determines whether there is a failure in the slot mapping table 400 of the slot (S139). When there is a failure (S139: YES), the read/write processing program 321 refers to the cache slot management information 317, and determines whether all blocks of the slot are dirty and formatted (S140). When no new data is written to any of the blocks (S140: NO), the processing ends.

When there is no failure in the slot mapping table 400 of the slot (S139: NO), or when all the blocks of the slot are dirty and formatted, the read/write processing program 321 executes the additional writing processing to store the data of the slot in the pool 230 and the storage drive 120 (S141). Details of the additional writing processing will be described later.

As described above, when there is a failure in the slot mapping table 400, new host data is written to the block associated with the volume in the upper layer. Therefore, the format data is written in the storage system 101 to an unallocated block.

For example, when the confirm button 507 is selected, the failure target data recovery processing activation program 324 instructs the failure target data recovery program 323 to write the format data for the failure slot.

As shown in FIG. 16, the failure target data recovery program 323 executes recovery processing for a designated slot. Since the cache area is already secured (S111: YES), the failure target data recovery program 323 determines the format range (S113).

The failure target data recovery program 323 refers to the failure address management information 318, and specifies a block (offset) that is not allocated to the volume in the upper layer in the failure slot. The failure target data recovery program 323 stores format data of the unformatted block in the cache area (S114).

Further, the failure target data recovery program 323 updates the dirty bitmap column 425 and the format bitmap column 427 of the slot in the cache slot management information 317 (S115). The updated information indicates that all data in the slot is dirty and formatted.

Next, the failure target data recovery program 323 determines whether all the data in the slot is dirty and formatted (S116). When all the data in the slot is dirty (S116: YES), the failure target data recovery program 323 executes the additional writing processing and stores the data of the slot in the pool 230 and the storage drive 120 (S117). When no new data is written to any of the blocks (S116: NO), the flow ends.

Formatting of the unallocated block may be executed after all host data of a list notified to the administrator is written, or in response to an instruction from the administrator. The server system 102 may write the host data of certain addresses among volume addresses associated with the failure slot. For example, the failure target data recovery program 323 can refer to the failure address management information 318 and determine a block in blocks of the slot as the failure target that does not have an allocation destination volume as an unallocated block.

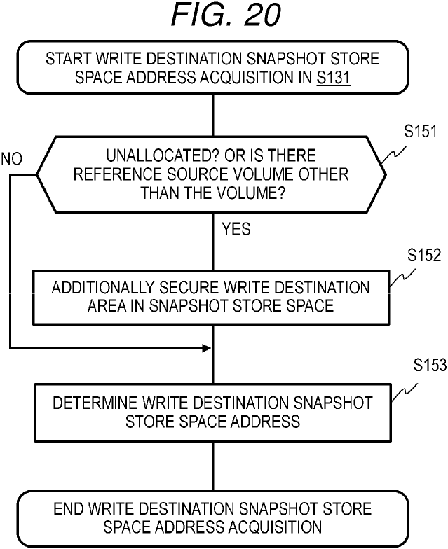

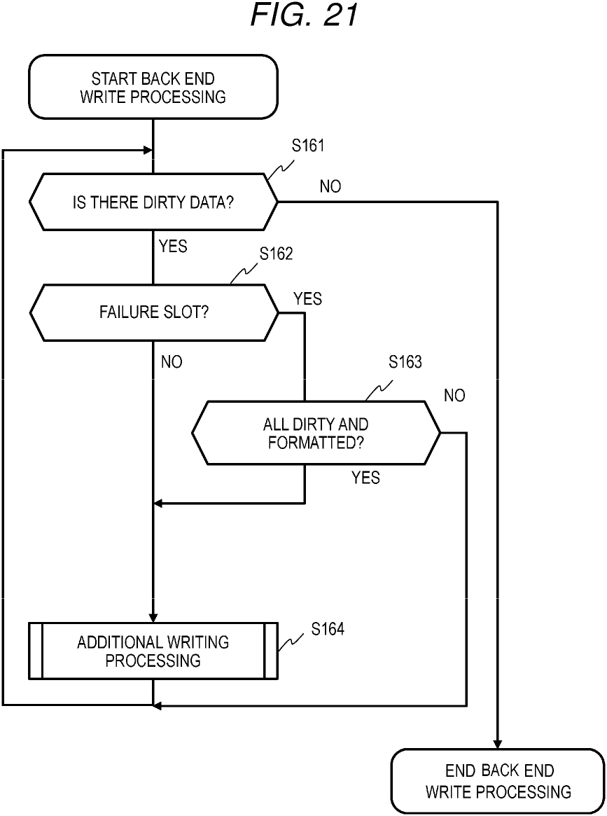

Next, details of the processing S131 of acquiring the write destination snapshot store space address of the host data in the flowchart of FIG. 19 will be described. FIG. 20 shows a flowchart of an example of write destination snapshot store space address acquisition processing in S131.

The read/write processing program 321 determines whether a write destination block of the snapshot store space 220 is allocated to a volume, and further determines whether the block is referred to by a volume in the upper layer other than the volume (S151). Specifically, the read/write processing program 321 acquires an entry corresponding to a write destination address of the volume in the upper layer from the snapshot store space mapping information 313 via the directory information 312.

When a value in the status column 372 is unallocated (“0”) (S151: YES), the read/write processing program 321 secures a new snapshot store space address (write destination area) (S152).

When the value in the status column 372 is allocated (“1”), there is an existing write destination snapshot store space address. When the existing snapshot store space address is registered, the read/write processing program 321 refers to the block reference source management information in the snapshot store space 319, and determines the reference source volume. When there is a reference source volume other than the volume (S151: YES), the read/write processing program 321 secures a new snapshot store space address (write destination area) (S152).

When the value in the status column 372 is allocated (“1”) and the reference source volume is the volume (the number of reference source volumes is 1) (S151: NO), step S152 is skipped.

The read/write processing program 321 determines a write destination snapshot store space address (S153). Specifically, when there is an existing snapshot store space address and the reference source volume is the volume, the existing snapshot store space address is the write destination.

When the write destination snapshot store space address is not allocated, a newly secured snapshot store space address is the write destination. When the allocated snapshot store space address is also referred to by another volume, the allocated block and the newly secured block are write destinations.

FIG. 21 shows a flowchart of an example of back end write processing. In the back end write processing, cached data in the snapshot store space 220 is written into the pool 230 and the storage drive 120. This processing enables additional writing processing of the cached data when processing is interrupted in the intermediate write processing or the failure data recovery processing.

The read/write processing program 321 refers to the dirty bitmap column 425 in the cache slot management information 317, and determines whether there is dirty cache data of the snapshot store space (S161). When there is no dirty cache data (S161: NO), the processing ends.

When there is dirty cache data (S161: YES), the read/write processing program 321 refers to the condition column 424 in the cache slot management information 317, and determines whether the slot is a failure slot (S162).

When the slot is a failure slot (S162: YES), the read/write processing program 321 refers to the dirty bitmap column 425 and the format bitmap column 427, and determines whether all blocks are dirty and formatted (S163). When all the blocks are dirty and formatted (S163: YES), the read/write processing program 321 executes the additional writing processing (S164). After the additional writing processing S164 is performed or when any one of the blocks is not dirty or formatted (S163: NO), a flow returns to step S161.

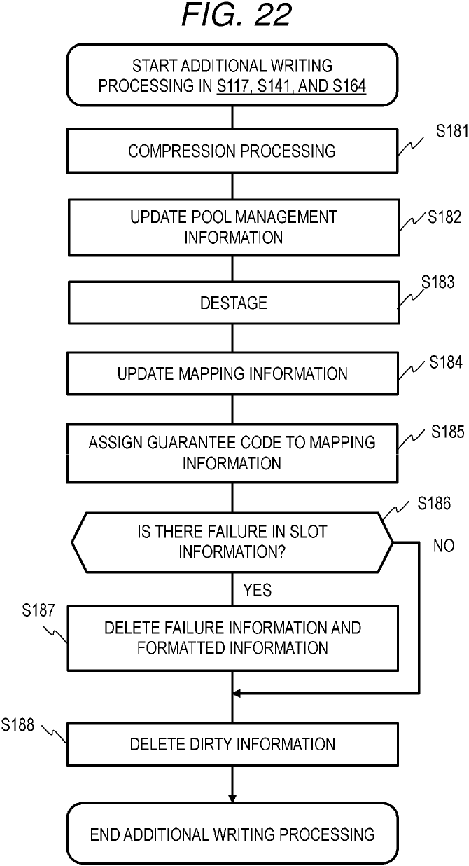

FIG. 22 shows a flowchart of an example of the additional writing processing. In the additional writing processing, data in the snapshot store space 220 is additionally written to the pool 230 and the storage drive 120. New data is sequentially stored in a free area of a page in the pool 230 in a forward packed manner. In the additional writing processing, the data virtually stored in the snapshot store space is compressed (S181), and then the pool mapping information 315 is updated (S182). The status column 402 and the reference destination pool address column 403 are updated for each block in the slot in the snapshot store space as an additionally writing target.

In the additional writing processing, compressed data in the memory 112 is destaged in the storage drive 120 (S183). In the additional writing processing, the slot mapping table 400 in the pool mapping information 315 is updated (S184), and a guarantee code is assigned (S185).

In the additional writing processing, the condition column 424 in the cache slot management information 317 is referred to to determine whether there is a failure in the slot mapping table 400 (S186). When there is a failure (S186: YES), failure information in the condition column 424 and formatted information in the format bitmap column 427 of the cache slot management information 317 are deleted. Finally, dirty information in the dirty bitmap column 425 of the cache slot management information 317 is deleted (S188) .

The invention is not limited to the above embodiment, and includes various modifications. For example, the embodiment described above is described in detail for easy understanding of the invention, and the invention is not necessarily limited to those including all configurations described above. A part of a configuration of one embodiment can be replaced with a configuration of another embodiment, and a configuration of another embodiment can be added to a configuration of one embodiment. A part of the configuration of each embodiment may be added, deleted, or replaced with another configuration.

Each of the above configurations, functions, processing units, or the like may be partially or entirely implemented by hardware such as design using an integrated circuit. The configurations, functions, and the like may also be implemented by software by interpreting and executing a program that implements each function by a processor. Information such as programs, tables, and files for implementing each function can be placed in a recording device such as a memory, a hard disk, and a solid state drive (SSD), or a recording medium such as an IC card and an SD card.

Control lines and information lines that are considered to be necessary for description are shown, and not all control lines and information lines on a product are necessarily shown. In practice, it may be considered that almost all the configurations are connected to each other.

What is claimed is:

1. A storage system comprising:
a controller, wherein
the controller
manages a logical device upper layer accessed by a host, a logical device lower layer, and a logical device middle layer between the logical device upper layer and the logical device lower layer, and
holds upper mapping information for managing an address relationship between the logical device upper layer and the logical device middle layer, and lower mapping information for managing an address relationship between the logical device middle layer and the logical device lower layer,
the lower mapping information includes a plurality of pieces of partial mapping information,
each of the plurality of pieces of partial mapping information manages address information of a partial area in the logical device middle layer, and
the controller writes, in response to a failure of first partial mapping information in the lower mapping information, new data that fills a first partial area in the logical device middle layer managed by the first partial mapping information, and regenerates the first partial mapping information.

2. The storage system according to claim 1, wherein
the new data includes format data generated by the controller.

3. The storage system according to claim 1, wherein
the new data includes host data received from the host that accesses the logical device upper layer.

4. The storage system according to claim 3, wherein
the controller generates and writes format data in an area that is not filled with the host data in the first partial area.

5. The storage system according to claim 3, wherein
the controller notifies a management system of address information of the host data stored in the first partial area in the logical device upper layer.

6. The storage system according to claim 1, wherein
the controller notifies a management system of the failure, and writes the new data in the first partial area in accordance with an instruction from the management system.

7. The storage system according to claim 1, wherein
the controller writes the new data to a storage drive after storing all of the new data in a cache area.

8. The storage system according to claim 1, wherein
the logical device upper layer includes a primary volume and a snapshot of the primary volume, and
the controller performs deduplication/compression processing on data in the logical device middle layer and writes the data in the logical device lower layer.

9. A control method for a storage system, wherein
the storage system holds upper mapping information for managing an address relationship between a logical device upper layer accessed by a host and a logical device middle layer, and lower mapping information for managing an address relationship between the logical device middle layer and a logical device lower layer,
the lower mapping information includes a plurality of pieces of partial mapping information,
each of the plurality of pieces of partial mapping information manages address information of a partial area in the logical device middle layer, and
the control method for a storage system comprises:
managing the logical device upper layer, the logical device middle layer, and the logical device lower layer by the upper mapping information and the lower mapping information; and
writing, in response to a failure of first partial mapping information in the lower mapping information, new data that fills a first partial area in the logical device middle layer managed by the first partial mapping information, and regenerating the first partial mapping information.
